(19) United States
(12) Patent Application Publication
(10) Pub. No.: US 2024/0185006 A1
(43) Pub. Date: Jun. 6, 2024

(54) METHOD OF DELIVERING ELECTRONIC BUSINESS CARD, AND NFC CHIP, PHONE CASE AND SERVER OF THE SAME

(71) Applicant: Shenzhen Aishubo Technology Co., Ltd., Shenzhen (CN)

(72) Inventor: Tsui Ka Yin, Hong Kong (CN)

(73) Assignee: Shenzhen Aishubo Technology Co., Ltd., Shenzhen (CN)

(21) Appl. No.: 18/060,974

(22) Filed: Dec. 2, 2022

(51) Int. Cl. G06K 7/10

(52) U.S. Cl. CPC G06K 7/10297

(57) ABSTRACT

A method of delivering an electronic business card based on NFC technology comprises the following steps of determining whether the NFC chip is at first contact at the time of detecting contact with a preset NFC chip, sending a preset server link to a smart terminal device corresponding to the contact when the NFC chip is at the first contact, wherein the preset server link is directed to a preset user information collecting page, receiving the user information that is input by a user of the smart terminal device according to the prompts on the user information collection page, and generating an electronic business card in a preset format based on the user information, and delivering the electronic business card to the smart terminal device corresponding to the contact when the NFC chip is not at the first contact.

### FIELD OF THE INVENTION

The present invention relates to the technical field of mobile communication technology and in particular to a method of delivering an electronic business card, and an NFC chip, a phone case and a server thereof based on NFC technology.

### BACKGROUND OF THE INVENTION

With the development of mobile communication technology, mobile terminal devices (e.g. mobile phones, Pads, etc.) have become an important communication tool between people. Compared to the traditional face-to-face way of collecting and identifying information between two parties, an electronic business card has arisen based on the wide development of mobile applications.

Electronic business cards are a digital card that digitally stores and transmits corporate or personal information and displays it in the form of graphics or audio. Compared to traditional paper business cards, the electronic business cards are not limited by geographic space, and deliver more information easier to be stored, but during a current delivery of address book files, there exist the following disadvantages.

Electronic business cards need have the aid of a specific mobile application, thus the way of opening the mobile application for the delivery of electronic business cards cannot meet the user's demand for rapid, large area delivery of communication information. For example, during exhibition, exhibitors want to be able to quickly spread their business cards to more viewers in a short time, so the exhibitors need to establish a connection with target viewers first, but obviously time-consuming is the process of pairing via Wifi or Bluetooth and then sending the business card to the target viewers one-to-one or one-to-many by means of a specific mobile application.

### SUMMARY OF THE INVENTION

The present invention provides a method of delivering an electronic business card, and an NFC chip, a phone case and a server thereof based on NFC technology, aiming to raise the delivery efficiency of electronic business cards.

In order to achieve the aforementioned objective, the present invention provides a method of delivering an electronic business card based on NFC technology, which includes the following steps:
at the time of detecting contact with a preset NFC chip, determining whether the NFC chip is at first contact,
sending a preset server link to the smart terminal device corresponding to the contact when the NFC chip is at the first contact, wherein the preset server link is directed to a preset user information collecting page,
receiving the user information that is input by a user of the smart terminal device according to the prompts on the user information collection page, and generating an electronic business card in a preset format based on the user information, and
delivering the electronic business card to the smart terminal device corresponding to the contact when the NFC chip is not at the first contact.

optionally, the step of determining whether the NFC chip is at first contact, includes the following sub steps:
getting the chip No. of the preset NFC chip at the time of detecting that the preset NFC chip is at contact,
querying in the preset server whether the preset NFC chip has been bound according to the chip No., and
determining that the predetermined NFC chip is at the first contact when the preset NFC chip has not been bound, or
determining that the predetermined NFC chip is not at the first contact when the preset NFC chip has been bound.

Optionally, the method further includes the following steps prior to the step of generating an electronic business card in a preset format based on the user information,
generating an user ID corresponding to the user information and getting the chip No. of the preset NFC chip,
binding the user ID to the chip No., and
storing the bound user ID and chip No. and the corresponding user information into a database corresponding to the preset server.

Optionally, the method further includes the following steps prior to the step of generating an electronic business card in a preset format based on the user information,
performing a duplication check on the user information,
performing an information completion operation on the user information finished with the duplication check, and
performing file error correction on the user information finished with the information completion operation to get the corrected user information.

Optionally, the step of generating an electronic business card in a preset format based on the user information includes the following sub steps:
marking the user information according to a preset business card label,
extracting a marked text content from the user information, and
converting the marked text content into a pre-formatted electronic business card.

Optionally, the method of delivering an electronic business card based on NFC technology further includes the following steps:
at the time of detecting that activation of a modification event done for the preset business card, performing user verification on the user of the smart terminal device corresponding to the activation, and
after passing the verification, sending the preset server link to the smart terminal device corresponding to the activation, receiving the modified user information input by the user of the smart terminal device corresponding to the activation, and updating the corresponding electronic business card according to the modified user information.

Optionally, the method further includes the following sub step subsequent to the step of performing user verification on the user of the smart terminal device corresponding to the activation,
at the time of not passing the verification, sending a message of the electronic business card without authorized modification to the smart terminal device corresponding to the activation.

In order to solve the above problems, the present invention also provides an NFC chip, the NFC chip generates a preset server link at its contact with a smart terminal device and sends the server link to the preset server, so that the preset server can perform the following operations according to the server link:
sending a preset server link to the smart terminal device corresponding to the contact when the NFC chip is at the first contact, wherein the preset server link is directed to a preset user information collecting page,
receiving the user information that is input by a user of the smart terminal device according to the prompts on the user information collection page, and generating an electronic business card in a preset format based on the user information, and
delivering the electronic business card to the smart terminal device corresponding to the contact when the NFC chip is determined to not be contacted at the first time.

In order to solve the above problems, the present invention also provides a phone case, the phone case is provided with the aforementioned NFC chip.

In order to solve the above problem, the present invention further provides a server, which includes:
at least one processor: and a memory communicatively connected to the processor,
wherein the memory stores the following functional modules that can be executed by the processor,
an NFC contact detection module used to at the time of detecting contact with a preset NFC chip determine whether the NFC chip is at first contact,
an user information collecting module used to send a preset server link to the smart terminal device corresponding to the contact when the NFC chip is at the first contact, wherein the preset server link is directed to a preset user information collecting page,
an electronic business card generating module used to receive the user information that is input by a user of the smart terminal device according to the prompts on the user information collection page, and generate an electronic business card in a preset format based on the user information, and
an electronic business card delivering module used to deliver the electronic business card to the smart terminal device corresponding to the contact when the NFC chip is not at the first contact.

The example of the present invention enables the users of smart terminal devices to send a server link directed to a preset user information collection page to the smart terminal device at contact with the NFC, so as to support them to maintain their own user information according to the prompts on the user information collection page, and finally generate an address book file based on the user information. Using the user information collection page to collect and maintain user information provides, on the one hand, a way to maintain user information in a uniform manner and, on the other hand, makes it unnecessary for users to install additional software, that is, enabling the maintenance of user's own information and the increase in the efficiency of generation and maintenance for electronic business cards. Delivering the address book file to the smart terminal device actuated with contact at the time of detecting that the preset NFC chip is not at first contact with it ensures the delivery efficiency of communication information. Therefore, the method of delivering an electronic business card based on NFC technology provides by the example of the present invention enables the increase in the delivery efficiency for electronic business cards.

### BRIEF DESCRIPTION OF THE DRAWINGS

FIG. 1 is a flow diagram of the method of delivering an electronic business card based on NFC technology provided by an example of the present invention.

FIG. 2 is a detailed flow diagram of one step within the method of delivering an electronic business card based on NFC technology provided by an example of the present invention.

FIG. 3 is a detailed flow diagram of another step within the method of delivering an electronic business card based on NFC technology provided by an example of the present invention.

FIG. 4 is a detailed flow diagram of another step within the method of delivering an electronic business card based on NFC technology provided by an example of the present invention.

FIG. 5 is a structure diagram of the server provided by an example of the present invention.

We shall further describe the effectuation, functional features and advantages of the present invention in connection with the examples and with reference to the figures.

### DETAILED DESCRIPTION OF SOME EMBODIMENTS

It should be understood that the specific embodiments described herein are merely intended to explain the present invention but not to limit it.

The examples of the present application provide an method of delivering an electronic business card based on NFC (Near Field Communication) technology. The execution subject of the method of delivering an electronic business card based on NFC technology includes, but is not limited to, at least one of an electronic device, such as a server and a terminal, capable of being configured to execute the method provided by the example of the present application. In other words, the method of delivering an electronic business card based on NFC technology may be executed by software or hardware installed on a terminal device or a server-side device, and the software may be a blockchain platform. The server side may be a standalone server or a cloud server providing basic cloud computing services such as cloud services, cloud database, cloud computing, cloud functions, cloud storage, network services, cloud communication, middleware services, domain name services, security services, content delivery network (CDN), and big data and AI platforms.

The present invention also provides an NFC chip, the NFC chip generates a preset server link at its contact with a smart terminal device and sends the server link to the preset server, so that the preset server can perform the following operations according to the server link:
sending a preset server link to the smart terminal device corresponding to the contact when the NFC chip is at the first contact, wherein the preset server link is directed to a preset user information collecting page,
receiving the user information that is input by a user of the smart terminal device according to the prompts on the user information collection page, and generating an electronic business card in a preset format based on the user information, and
delivering the electronic business card to the smart terminal device corresponding to the contact when the NFC chip is determined to not be contacted at the first time.

The present invention also provides a phone case, which may be provided with the aforementioned NFC chip. It should be noted that the NFC chip can be installed on any physical carrier besides the phone case, for example, a wallet case, a handbag case, a poster, etc.

Referring to FIG. 1, there is a flow diagram of the method of delivering an electronic business card based on NFC technology provided by an example of the present invention shown. In this example, the method of delivering an electronic business card based on NFC technology includes the following steps.

S1. At the time of detecting contact with a preset NFC chip, determining whether the NFC chip is at first contact.

In the examples of the present invention, the preset NFC (Near Field Communication) chip may be installed on any physical carrier, for example, a wallet case, a poster, a phone case, a handbag's surface, etc. Currently, mobile phones have become an important communication tool between people with their wide use. Therefore, preferably, the preset NFC chip may be installed on the phone case following users, so as to expand the movement range of the preset NFC chip and support the users to generate and exchange electronic business cards anytime and anywhere.

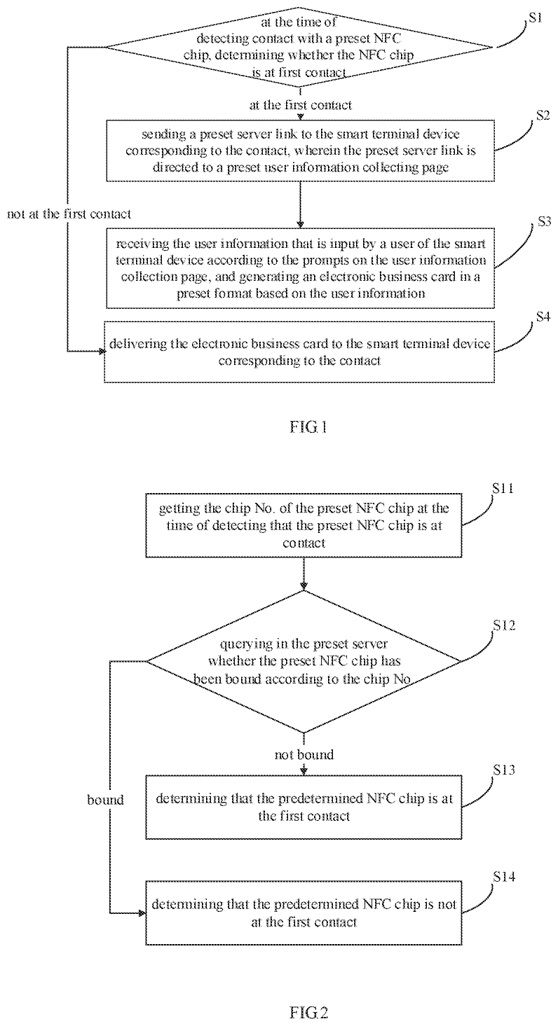

In detail, referring to FIG. 2, by the following method is whether the preset NFC chip is at first contact determined,

S11. getting the chip No. of the preset NFC chip at the time of detecting that the preset NFC chip is at contact,

S12. querying in the preset server whether the preset NFC chip has been bound according to the chip No., and
executing the step S13 of determining that the predetermined NFC chip is at the first contact, when the preset NFC chip has not been bound, or
executing the step S14 of determining that the predetermined NFC chip is not at the first contact, when the preset NFC chip has been bound.

In the examples of the present invention, the chip No. is a set of strings used to uniquely identify the NFC chip, and each preset NFC chip corresponds to a unique chip No., but the length and composition of this chip No. can be customized according to the actual business situation. For example, the chip No. consists of 7 characters, where the first 5 characters are numerals and the last 2 characters are English letters.

In the examples of the present invention, the preset server refers to a server pre-establishing a communication connection with the preset NFC chip, this server provides business functions such as writing and modifying user information and generating and sending user electronic business cards.

Preferably, the preset server link may be pre-written into the preset NFC chip, only needed to open the NFC function and put a smart terminal device at contact with the NFC chip, can users receive the server link pre-stored in the NFC chip and display an user information collection page corresponding to the server link.

S2. Sending a preset server link to the smart terminal device corresponding to the contact when the NFC chip is at the first contact, wherein the preset server link is directed to a preset user information collecting page.

In the examples of the present invention, the smart terminal device refers to a device functioning as NFC, including but not limited to a mobile phone, a PAD, a notebook computer, etc.

In the examples of the present invention, the preset user information collection page may be configured according to actual business needs, for example, the user information collection page may provide input boxes for collecting information such as an user ID, a name, a home address, work information and other contact information of communication software, etc., also provide an user registration function to bind the preset NFC chip to the user, achieving uniqueness of user information and establishing an one-to-one correspondence between user information and the NFC chip, so as to raise the management efficiency of the NFC chip and user information.

In an example of the present invention, after users have purchased the preset NFC chip, they can put any mobile terminal device with an NFC function at contact with the preset NFC chip, sending a link directed to a preset user information collection page to the smart terminal device at first contact with the preset NFC chip, so as to provide a way to input user information for the user of the smart terminal device, and the users can log in to the user information collection page to input relevant information without necessity to additionally download other software.

S3. Receiving the user information that is input by a user of the smart terminal device according to the prompts on the user information collection page, and generating an electronic business card in a preset format based on the user information.

In the examples of the present invention, the user of the smart terminal device actuated with first contact opens the server link, enters the user information collection page and fills in relevant information such as a name, a mobile phone number and address information, according to the prompts on the user information collection page.

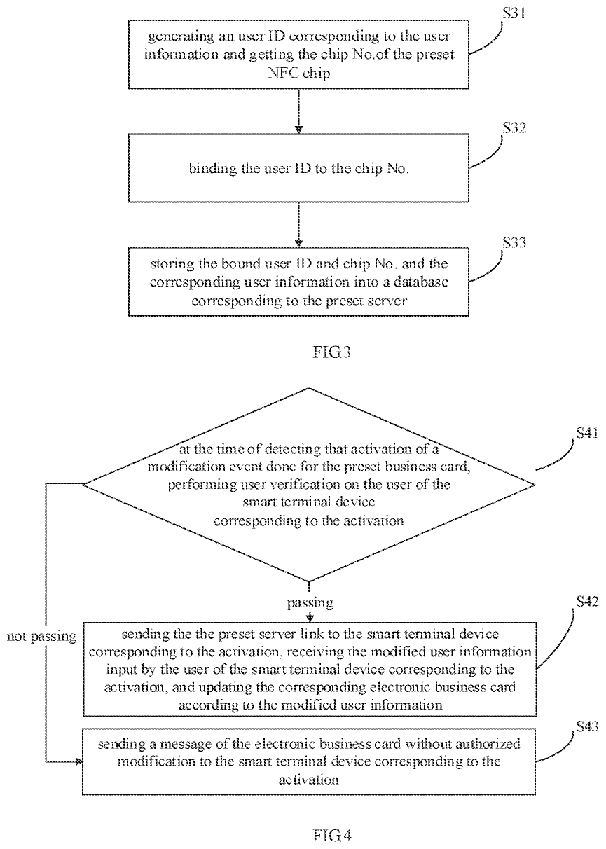

In order to ensure an one-to-one correspondence between the user information and the preset NFC chip, in the examples of the present invention, referring to FIG. 3, by the following method prior to the step of generating an electronic business card in a preset format based on the user information is the binding relationship between the user information and the preset NFC chip achieved:

S31. generating the user ID corresponding to the user information and getting the chip No. of the preset NFC chip,

S32. binding the user ID to the chip No., and

S33. storing the bound user ID and chip No. and the corresponding user information into a database corresponding to the preset server.

In the examples of the present invention, a unique user ID can be generated by adopting a random method.

In the examples of the present invention, by binding the user ID to the chip No. can be established an one-to-one relationship between the chip and the user, which ensures that one subsequent chip only corresponds to the communication information of one user.

Preferably, the database corresponding to the preset server may be any non-relational database, for example, oracle or mysql. The user ID and the chip No. can be stored with the user information corresponding to them as a joint primary key.

Further, in order to improve the security of the user information storage, the user information may be encrypted before its storage, then stored after the encryption.

Understandably, when inputting the above user information, users may duplicate, omit or incorrectly input information. Thus, preferably, by the following method prior to the step of generating an electronic business card in a preset format based on the user information may be a normalized pre-process operation performed on the user information:
performing a duplication check on the user information,
performing an information completion operation on the user information finished with the duplication check, and
performing file error correction on the user information finished with the information completion operation to get the corrected user information.

In an optional example of the present invention, the step of generating an electronic business card in a preset format based on the user information may be achieved by the following method, which includes:
marking the user information according to a preset business card label,
extracting a marked text content from the user information, and
converting the marked text content into a pre-formatted electronic business card.

In the examples of the present invention, the preset business card label can be set according to actual business needs, including but not limited to labels of a user's name, a user's address, user's contact information and so on. The pre-formatted electronic business card can be in a VCF file format, which is the standard file format for electronic business cards.

In the examples of the present invention, using the user information collection page to collect and maintain user information provides, on the one hand, a way to maintain user information in a uniform manner and, on the other hand, makes it unnecessary for users to install additional software, that is, enabling the maintenance of user's own information and the increase in the efficiency of generation and maintenance for electronic business cards.

S4. delivering the electronic business card to the smart terminal device corresponding to the contact when the NFC chip is determined to not be contacted at the first time.

In the examples of the present invention, when the preset server detects that the preset NFC chip is not at first contact, that is, the preset NFC chip has been bound, then obtained is the chip No. of the NFC chip, the electronic business card corresponding to which is queried in the preset server. Thus, the queried electronic business card is used as the electronic business card corresponding to the preset NFC chip and delivered to all smart terminal devices actuated with contact. Users save the delivered electronic business card at receipt of it. The aforementioned method enables the delivery of the user's electronic business card.

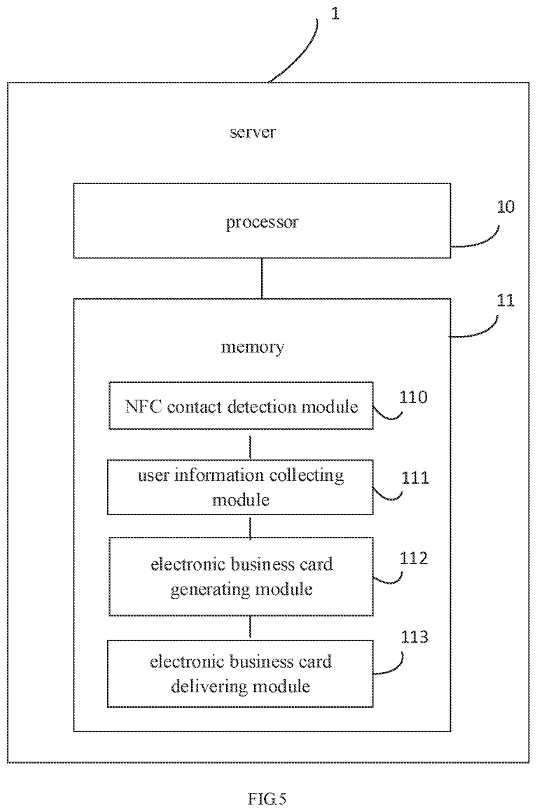

In an optional example of the present invention, referring to FIG. 4, by the following method may also be the electronic business card modified,

S41. at the time of detecting that activation of a modification event done for the preset business card, performing user verification on the user of the smart terminal device corresponding to the activation,
after passing the verification, executing the step S42 of sending the preset server link to the smart terminal device corresponding to the activation, receiving the modified user information input by the user of the smart terminal device corresponding to the activation, and updating the corresponding electronic business card according to the modified user information, and
at the time of not passing the verification, executing the step S43 of sending a message of the electronic business card without authorized modification to the smart terminal device corresponding to the activation.

In the examples of the present invention, an update button or an update hotkey may be set in the electronic business card, and a tracking event for modifying the business card may be bound to the update button or the update hotkey. Thus, users can click on the update button or click on the update hotkey at receipt of the electronic business card, thereby activating a preset business card modifying event.

In the examples of the present invention, users can set a user identification password or other user identification information according to the prompts on the preset user information collecting page at their first use of the page. The step of performing user verification on the user of the smart terminal device corresponding to the activation includes, but is not limited to, methods such as sending password verification information or identity Q&A information to the user of the smart terminal device.

In the examples of the present invention, when passing the verification, the preset server sends the preset server link to the smart terminal device started with activation, then users modify the user information according to the prompts on the preset user information collecting page.

In the examples of the present invention, when a preset business card modifying event is detected in activation, the verification on the user of the smart terminal device started with activation ensures the security of the modification to the electronic business card. A way for users to update their electronic business cards is provided by sending a server link to the preset user information collecting page to the users who pass the verification, allowing the users to modify the user information without necessity for them to additionally download software.

The examples of the present invention enable the users of smart terminal devices to send a server link directed to a preset user information collection page to the smart terminal device at contact with the NFC, so as to support them to maintain their own user information according to the prompts on the user information collection page, and finally generate an address book file based on the user information. Using the user information collection page to collect and maintain user information provides, on the one hand, a way to maintain user information in a uniform manner and, on the other hand, makes it unnecessary for users to install additional software, that is, enabling the maintenance of user's own information and the increase in the efficiency of generation and maintenance for electronic business cards. Delivering the address book file to the smart terminal device actuated with contact at the time of detecting that the preset NFC chip is not at first contact with it ensures the delivery efficiency of communication information. Therefore, the method of delivering an electronic business card based on NFC technology provides by the examples of the present invention enables the increase in the delivery efficiency for electronic business cards.

As shown in FIG. 5, there is a structure diagram of the server provided by an example of the present invention.

The server 1 may include a processor 10, a memory 11 and a bus, as well as computer programs such as an NFC contact detection module 110, an user information collecting module 111, an electronic business card generating module 112 and an electronic business card delivering module 113, stored in the memory 11 and operational on the processor 10. In these examples, the module, which may also be called a unit, refers to a series of computer program segments capable of performing a steady function.

In the examples of the present invention, the functions of the modules/units are provided as follows:
the NFC contact detection module 110 used to at the time of detecting contact with a preset NFC chip determine whether the NFC chip is at first contact,
the user information collecting module 111 used to send a preset server link to the smart terminal device corresponding to the contact when the NFC chip is at the first contact, wherein the preset server link is directed to a preset user information collecting page,
the electronic business card generating module 112 used to receive the user information that is input by a user of the smart terminal device according to the prompts on the user information collection page, and generate an electronic business card in a preset format based on the user information, and
the electronic business card delivering module 113 used to deliver the electronic business card to the smart terminal device corresponding to the contact when the NFC chip is not at the first contact.

Among them, the memory 11 includes at least one type of readable storage medium, which includes a flash memory, a removable hard disk, a multimedia card, a card-type memory (e.g. SD or DX memory, etc.), a magnetic memory, a disk, an optical disk, etc. In some examples, the memory 11 may be an internal storage unit of the server 1, such as a removable hard disk of this server 1. In other examples, the memory 11 may also be an external storage device for server 1. such as a plug-in removable hard drive, a SMC (Smart Media Card), a SD (Secure Digital) card and a flash card, possibly equipped on the server 1. Further, the memory 11 may also include both the internal storage units and external storage devices of the server 1. The memory 11 can be used not only to store the application software and the various types of data both installed on the server 1. such as codes of electronic business card transmission program, but also to temporarily store data that has been or will be output.

The processor 10 may in some examples consists of an integrated circuit such as an integrated circuit singly packaged, or consists of a plurality of integrated circuits packaged with the same or different functions, including one or more central processing units (CPUs), microprocessors, digital processing chips, graphics processors and a combination of various control chips. The processor 10 is the control core (Control Unit) of the electronic device and connects the various components of the entire electronic device by means of various interfaces and lines, so as to perform the various functions of the server 1 and process data by operating or executing the programs or modules stored in the memory 11 (e.g. an electronic business card transmission program, etc.) and by invoking the data stored in the memory 11.

The bus may be a PCI (peripheral component interconnect) bus or an EISA (extended industry standard architecture) bus. The bus can be classified into an address bus, a data bus, a control bus, etc. The bus is configured to enable connection communication between the memory 11 and at least one processor 10.

FIG. 5 only shows a server with components, and it is understandable for a person skilled in the art that the structure illustrated in FIG. 5 does not impose a limitation on the server 1 and may include components fewer or more than those in the drawing, or a combination of some components, or an arrangement of different components.

For example, although not shown, the server 1 may also include a power source (e.g. a battery) to power each component: preferably the power source may be logically connected to the processor 10 by means of a power management device, which achieves the functions such as charging management, discharging management, and power consumption management. The power source may also include one or more DC or AC power sources, re-charging devices, power fault detection circuits, power converters or inverters, power status indicators and any other components. The server 1 may also include a variety of sensors, Bluetooth modules, Wi-Fi modules and the like, which will not be described herein.

Further, the server 1 may further include a network interface, optionally the network interface may include a wired interface and/or a wireless interface (e.g. a WI-FI interface, a Bluetooth interface, etc.), which is typically used to establish a communication connection between this server 1 and other electronic devices.

Optionally, the server 1 may also include a user interface, which may be a display, an input unit (e.g. a keyboard), or optionally be a standard wired interface or wireless interface. Optionally, in some examples, the display may be a LED display, a LCD display, a touchscreen LCD display, an OLED (Organic Light-Emitting Diode) touch device and the like. Among them, the display may also be suitably referred to as a display or display unit, which is used to display information processed in the server 1 as well as a visualized user interface.

It should be understood that the examples described herein only serve as an illustration, but the structure involved therein does not impose a limitation on the scope of the patent application.

The electronic business card transmission program stored in the server 1 is a combination of several instructions, which run in the processor 10, so as to achieve:
at the time of detecting contact with a preset NFC chip, determining whether the NFC chip is at first contact,
sending a preset server link to the smart terminal device corresponding to the contact when the NFC chip is at the first contact, wherein the preset server link is directed to a preset user information collecting page,
receiving the user information that is input by a user of the smart terminal device according to the prompts on the user information collection page, and generating an electronic business card in a preset format based on the user information, and
delivering the electronic business card to the smart terminal device corresponding to the contact when the NFC chip is not at the first contact.

Further, the modules/units integrated in the server 1 may be stored in a computer-readable storage medium in the case that they are effectuated as a software functional unit, and sold or used as a stand-alone product. The computer-readable storage medium may be volatile or non-volatile. For example, the computer-readable storage medium may include: any entity or device capable of carrying the computer program codes, such as a recording medium, an USB disk, a removable hard disk, a magnetic disk, an optical disk, a computer memory and a read-only memory (ROM).

In addition, the functional modules in each example of the invention may be integrated in one processing unit, or consist of physically individual units respectively, or be integrated of two or more units in one unit. The aforementioned integrated units can be effectuated either as hardware or as hardware plus software functional modules.

As for a person skilled in the art, it is obvious that the invention is not limited to the details of the aforementioned illustrative examples and can be effectuated in other specific forms without departing from the essence or essential features of the invention.

Therefore, from whichever point of views should be the examples deemed to be illustrative and nonrestrictive and is the scope of the invention defined by the appended claims instead of the aforementioned description, so as to intendedly enable the present invention to contain all variations falling within the meaning and scope of the equivalent elements of the claims. Any mark related to the drawings in the patent claims should not be regarded as a limit on the involved patent claims.

The blockchain referred to in the present invention is a new application model for distributed data storage, point-to-point transmission, consensus mechanisms, cryptographic algorithms and other computer technologies. The blockchain, essentially a decentralized database, is a string of data blocks generated by adopting association with a cryptographic method, and each data block contains information about a batch of network transactions, which is used to verify the validity of its information (Anti-Fake) and to generate the next block. A blockchain may include a blockchain underlying platform, a platform product service layer and an application service layer.

The examples of the present application can be based on a holographic projection technology to get and process relevant data. Among them, artificial intelligence (AI) is a principle, method, technology and application system making use of digital computers or machines controlled by digital computers to simulate, widen and extend human intelligence, perceive environment, get knowledge and use it to attain an optimal result.

In addition, obviously, the word “include” does not exclude other units or steps and the singular does not exclude the plural. A plurality of units or devices described in the system claims can also be constituted by one unit or device via software or hardware. The words such as second are used to denote names and do not indicate any particular order.

Finally, it should be noted that the aforementioned examples are only intended to illustrate the technical solution of the present invention and not to limit the latter. Although the invention has been described in detail with reference to the preferred examples, a person skill in the art should understand that modifications or equivalent substitutions can be made to the technical solution of the invention without departing from the essence and scope of the technical solution of the present invention.

What is claimed is:

1. A method of delivering an electronic business card based on NFC (Near Field Communication) technology, comprising:
when detecting a contact of a preset NFC chip with a smart terminal device, determining whether the NFC chip is contacted with the smart terminal device at a first time,
sending a preset server link to the smart terminal device corresponding to the contact when the NFC chip is determined to be contacted at the first time, wherein the preset server link is directed to a preset user information collecting page,
receiving user information that is input by a user of the smart terminal device according to prompts on the user information collecting page, and generating the electronic business card in a preset format based on the user information, and
delivering the electronic business card to the smart terminal device corresponding to the contact when the NFC chip is determined to not be contacted at the first time.

2. The method according to claim 1, wherein determining whether the NFC chip is contacted at a first time comprises:
getting a chip No. of the preset NFC chip when detecting that the preset NFC chip is contacted,
querying in the preset server whether the preset NFC chip has been bound to the preset server according to the chip No., and
determining that the predetermined NFC chip is contacted at the first time when the preset NFC chip has not been bound, or
determining that the predetermined NFC chip is not contacted at the first time when the preset NFC chip has been bound.

3. The method according to claim 1, wherein prior to generating an electronic business card in a preset format based on the user information, the method further comprises:
generating an user ID corresponding to the user information and getting a chip No. of the preset NFC chip,
binding the user ID to the chip No., and
storing the bound user ID and the chip No. and the corresponding user information into a database corresponding to the preset server.

4. The method according to claim 1, wherein prior to generating the electronic business card in a preset format based on the user information, the method further comprises:
removing duplicate information on the user information,
supplementing information on the user information after removing the duplicate information, and
correcting errors on the user information after supplementing the information to get a corrected user information.

5. The method according to claim 1, wherein generating the electronic business card in a preset format based on the user information comprises:
marking the user information according to a preset business card label,
extracting a marked text content from the user information, and
converting the marked text content into a pre-formatted electronic business card.

6. The method according to claim 1, wherein the method further comprises:
when detecting that activation of a modification event for the preset business card, performing user verification on the user of the smart terminal device corresponding to the activation, and
when passing the verification, sending the preset server link to the smart terminal device corresponding to the activation, receiving the modified user information input by the user of the smart terminal device corresponding to the activation, and updating the corresponding electronic business card according to the modified user information.

7. The method according to claim 6, wherein subsequent to performing user verification on the user of the smart terminal device corresponding to the activation, the method further comprises:
when fail to pass the verification, sending a message that the electronic business card is not authorized to modify to the smart terminal device corresponding to the activation.

8. A NFC chip, wherein the NFC chip generates a preset server link when contacted with a smart terminal device and sends the server link to the preset server, the preset server performs the following operations according to the server link:
sending the preset server link to the smart terminal device corresponding to the contact when the NFC chip is determined to be contacted at the first time, wherein the preset server link is directed to a preset user information collecting page,
receiving user information that is input by a user of the smart terminal device according to prompts on the user information collecting page, and generating an electronic business card in a preset format based on the user information, and
delivering the electronic business card to the smart terminal device corresponding to the contact when the NFC chip is determined to not be contacted at the first time.

9. (canceled)

10. A server comprising:
at least one processor; and
a memory communicatively connected to the processor,
wherein the memory stores the following functional modules that can be executed by the processor,
NFC contact detection module used to detect a contact of a preset NFC chip to determine whether the NFC chip is contacted with a smart terminal device at a first time,
an user information collecting module used to send a preset server link to the smart terminal device corresponding to the contact when the NFC chip is determined to be contacted at the first time, wherein the preset server link is directed to a preset user information collecting page,
an electronic business card generating module used to receive user information that is input by a user of the smart terminal device according to prompts on the user information collecting page, and generate an electronic business card in a preset format based on the user information, and
an electronic business card delivering module used to deliver the electronic business card to the smart terminal device corresponding to the contact when the NFC chip is determined to not be contacted at the first time.
